(19) United States
(12) Patent Application Publication
(10) Pub. No.: US 2014/0082744 A1
(43) Pub. Date: Mar. 20, 2014

(54) AUTOMATIC SHARING OF USER INTERACTIONS

(71) Applicants: Reza BEHFOROOZ, Mountain View, CA (US); Sathyanarayana GIRIDHAR, Palo Alto, CA (US)

(72) Inventors: Reza BEHFOROOZ, Mountain View, CA (US); Sathyanarayana GIRIDHAR, Palo Alto, CA (US)

(73) Assignee: Google Inc., Mountain View, CA (US)

(21) Appl. No.: 13/619,549

(22) Filed: Sep. 14, 2012

(51) Int. Cl. G06F 15/16; G06F 21/00

(52) U.S. Cl. 726/27; 709/204

(57) ABSTRACT

The subject disclosure relates to a method comprising steps for receiving reference object information, wherein the reference object information is based on a first user's interaction with a content item, determining that a second user is interacting with the content item, receiving item object information, wherein the item object information is based on the second user's interaction with the content item and determining that the second user has access rights to the reference object information based on the second user and the second user's interaction with the content item. In certain aspects, the method can further comprise steps for providing at least a portion of the reference object information for an electronic device associated with the second user. Systems and computer-readable media are also provided.

### BACKGROUND

In many online contexts, a user may wish to share information with one or more of the user's online associates, regarding a content item with which the user has interacted online For example, a user may share links to online content such as music or video, or may share information regarding products or services that have been purchased by the user. In some instances the user may use a social network to provide information (e.g., about a content item), to one or more of the user's associates in the social network.

### SUMMARY

The present disclosure generally relates to a method for providing a user with supplemental information regarding an online content item and, in particular, personalized information related to one or more of the user's social networking associates.

In certain aspects, the disclosed subject matter relates to computer-implemented method comprising, receiving reference object information, wherein the reference object information is based on a first user's interaction with a content item, determining that a second user is interacting with the content item, receiving item object information, wherein the item object information is based on the second user's interaction with the content item and determining that the second user has access rights to the reference object information based on the second user and the second user's interaction with the content item. In certain aspects the method further comprises steps for providing at least a portion of the reference object information for an electronic device associated with the second user.

The disclosed subject matter also relates to a system comprising one or more processors and a computer-readable medium comprising instructions stored therein, which when executed by the processors, cause the processors to perform operations comprising, receiving reference object information, wherein the reference object information comprises a first user identification and wherein at least a portion of the reference object information is based on a first user's interaction with a content item, receiving item object information, wherein the item object information is based on a second user's interaction with the content item and determining that the second user has access rights to the reference object information based on the second user and the second user's interaction with the content item. In certain aspects, the processors are further to perform operations for providing at least a portion of the reference object information for an electronic device associated with the second user.

In yet another aspect, the subject technology relates to a computer-readable medium comprising instructions stored thereon, which when executed by a processor, cause the processor to perform operations comprising, receiving reference object information, wherein the reference object information comprises a first user identification and wherein at least a portion of the reference object information is based on a first user's interaction with a content item, determining that a second user is interacting with the content item and receiving item object information, wherein the item object information comprises a second user identification, and wherein at least a portion of the item object information is based on the second user's interaction with the content item. In certain aspects, the instructions can cause the processor to perform operations for providing at least a portion of the reference object information for an electronic device associated with the second user.

These and other aspects can include one or more of the following features. The reference object information can comprise a first user identification. The reference object information can comprise a content item identification. The reference object information can comprise an access control list. The access control list can comprise information for identifying one or more social networking associates of the first user and determining whether the second user has access rights to the reference object can be based on the access control list. The reference object information can comprise information related to the first user's preferences with respect to the content item. The reference object information can comprise information related to a purchase made by the first user with respect to the content item. The electronic device associated with the second user can receive the reference object information from a third party service. The item object information can comprise a content item identification.

Implementations of the subject technology can facilitate the sharing of information between users outside the context of a social network. For example, sharing of certain types of information can be performed on a third party website at the time a user is viewing a particularly relevant content item. By providing relevant information relating to a content item (at a time when a user is viewing the content item), aspects of the subject technology serve to increase the relevance of information that is shared between users.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative, and not restrictive in nature.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the disclosed aspects. In the drawings:

FIG. 1 illustrates a block diagram of an example system for implementing one or more aspects of the subject technology.

FIG. 2 illustrates steps of a method for providing supplemental content item information to a consuming user, according to some aspects of the disclosure.

FIG. 3 illustrates an example of a graphical user interface that can be used by a producing user according to certain aspects of the subject disclosure.

FIG. 4 illustrates an example of a graphical user interface that can be used by a consuming user, according to certain aspects of the subject disclosure.

FIG. 5 illustrates an example of a network system with which some aspects of the subject technology can be implemented.

FIG. 6 illustrates an example of an electronic system that can be used to implement certain aspects of the subject technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent to those skilled in the art that the subject technology is not limited to the specific details set forth herein and may be practiced without these specific details. In some instances, certain structures and components are shown in block diagram form in order to avoid obscuring the concepts of the subject technology.

In some social networking implementations, a user can provide information to one or more members of their social network, regarding content items that the user encountered online, e.g., on a third party website. For example, a user shopping for a book on a third party site can “share” his purchase with members of his social circle or network, e.g., using a widget or application programming interface (API) executed on the third party site. Information regarding the book is then made available to one or more of the user's social network associates, within the context of the social network. However, it would be useful to provide context specific information about a content item to one or more of the user's social network associates, outside the scope of the social network e.g., on the third party website where (and when) the content item is encountered.

The subject technology provides a method by which information related to a content item can be provided to one or more social networking associates (e.g., one or more “consuming users”) as they view or interact with the content item, for example, on a third party site.

In certain aspects, a user (e.g., a “producing user” or a “first user”) can interact with a content item, for example, by viewing, purchasing, rating, commenting on, or downloading the content item. As used herein a “content item” can comprise various types of information or content capable of transmission over a network. By way of example, a content item can comprise video information, audio information or text. In certain aspects, a content item can comprise a product or service offered for sale (e.g., a listing for a book sold by an online book retailer).

After the producing user interacts with the content item, a reference object can be created based on the producing user's interaction with the content item. The reference object can contain different types of information relative to the content item and/or to the producing user. For example, the reference object can contain user designated information that includes user reviews of the content item, or information pertaining to the user's interaction with the content item, such as purchase details, etc. The reference object can further include site identification information (e.g., for identifying a website where the reference object originated), item reference information (e.g., for identifying the content item), access control list information (e.g., for identifying sharing rights) and/or user identification information (e.g., for identifying the producing user).

In some implementations, the producing user can specify sharing rights that will be included in the reference object (e.g., by selecting one or more groups, circles or individual contacts to designate social networking associates that are granted access the information of the reference object). The reference object can then be forwarded from the third party site to a central location (e.g., a “verification service” such as one or more servers in a social network).

When another user, (e.g., a “consuming user” or a “second user”) interacts with the same content item (or a similar content item), the consuming user's interaction can cause an “item object” to be created, and forwarded to the verification service (e.g., one or more servers of the social network). The item object can comprise different types of information about the consuming user and/or about the content item and the context of the interaction between the consuming user and the content item. In certain aspects the item object will contain a designation of the third party site, an identifier for the content item and a user identification that identifies the consuming user.

Once the item object is received by the verification service (e.g., the social network), the item object can be matched with one or more reference objects that are already stored by the social network. Matches between an item object and a reference object can be made based on a number of criteria. For example, a particular item object and reference object can be matched based on the respective user identification information, the originating site, the content item and/or the access control list specified by the producing user. If a match is made between an item object and a reference object, the matching reference object can then be forwarded to the third party site, in order to provide the consuming user with information regarding the producing user's interaction with the content item.

The information provided to the consuming user can also comprise different types of information. By way of example, a producing user can purchase a concert ticket and may be provided with a specific seating assignment. Information related to the concert and seat assignment can be stored in the reference object. When a friend of the producing user (e.g., a consuming user) views the same content item, e.g., purchases tickets for the same concert, the consuming user can be provided with the seat assignment of the producing user.

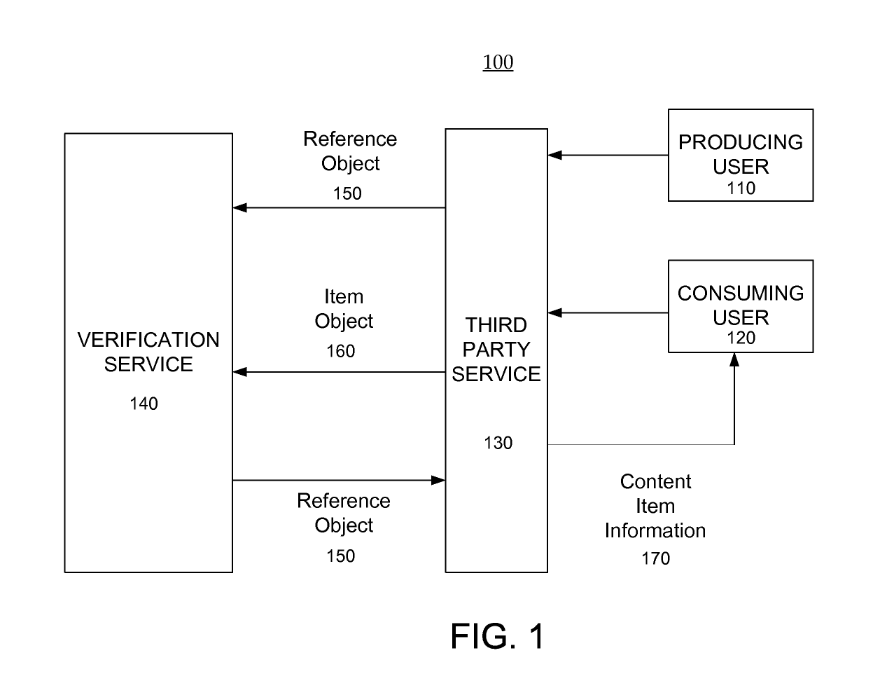

FIG. 1 illustrates a block diagram of an example system 100 for implementing one or more aspects of the subject technology. The system 100 comprises a producing user 110, a consuming user 120, a third party service 130 and a verification service 140. The various components system 100 are configured for sending and receiving information of various types, for example a reference object 150, an item object 160 and content item information 170.

In certain aspects, the producing user 110 and the consuming user 120 will be different users associated with different electronic devices. As will be explained in further detail below, the producing user 110 and the consuming user 120 can be associated with different devices configured to transact data via a network. By way of example, the producing user 100 and the consuming user 120 may each be associated with a personal computer or a mobile computing device such as a tablet PC, smart phone or laptop, etc.

Additionally, the third party service 130 and the verification service 140 can separately comprise one or more computing devices such as one or more personal computers or servers. In some implementations, the third party service 130 and/or the verification service 140 may comprise a network of computing devices (e.g., a social network).

Although the third party service 130 can comprise one or more computing devices, in some aspects the third party service can comprise a server for hosting online content (e.g., a webpage or internet based service). By way of example, the third party service can comprise an online business or store front, such as an online book store.

In some examples, the producing user 110 will visit the third party service 130 and will browse one or more content items provided to the producing user 110 by the third party service 130. The one or more content items can comprise different types of information content, such as image, video, text or audio data. In some examples, the content item can comprise a listing for a product or service, for example, a listing for a book sold in the online bookstore.

Based on the producing user's interaction with the third party service 130, the third party service will generate a reference item object 150 to be sent to the verification service 140. In some aspects, the reference object 150 can be automatically generated by the third party service 130. In other aspects, the reference object 150 may be generated in response to a request received from the producing user 110. For example, the producing user 110 may provide the third party service 130 with an indication that he/she wishes to provide information (e.g., information related to a particular content item) to one or more consuming users.

The consuming users can be any users who are able interact with the third party service 130. In certain aspects one or more consuming users can be one or more users with whom the producing user 110 is affiliated via a social networking service. By way of example, one or more potential consuming users may be social networking contacts, acquaintances, friends and/or social networking associates that belong to one or more social networking groups or circles of the producing user 110. Thus, when the producing user 110 specifies to the third party service 130 that he/she wishes to provide information to one or more consuming users, the producing user 110 may specify one or more social networking associates, groups or circles, with whom the information can be shared.

The generated reference object 150 can comprise different types of information produced by the producing user and/or information relevant to the producing user's interaction with the third party service 130 and/or the content item. In certain aspects, the reference object 150 will comprise information identifying the origination site (e.g., the third party service 130), one or more content items, a producing user identification, an access control list and information related to the producing user's interaction with one or more content items and/or the third party service 130.

An access control list of the reference object 150 can include information indicating privacy settings for the producing user 110 and/or may specify one or more consuming users (e.g., the consuming user 120) with which information of the reference object 150 can be shared.

By way of example, if the producing user decides to buy a book from an online book store hosted on the third party service 130, the producing user 110 may specify one or more consuming users (e.g., social networking associates, contacts, friends, groups or circles) with whom information regarding the producing user's purchase can be shared.

In another implementation, information regarding the producing user can be shared with one or more consuming users based on a rule or policy that is set by the producing user. For example, the producing user may specify a threshold level of social affinity for users with whom information about the producing user can be shared. Additionally, the producing user's indication regarding which consuming users can receive information regarding the purchase may be received via a software widget or via an application programming interface (API) provided by the third party service 130.

After the reference object 150 is generated, it is sent from the third party service 130 to the verification service 140. Upon receiving the reference object 150, the verification service 140 stores the reference object 150. Although the verification service 140 can comprise different types of computing devices capable of network communication, in some implementations the verification service 140 can include one or more computers or servers that are part of a social networking platform.

Subsequently, when the consuming user 120 visits the third party service 130, an item object will be sent from the third party service 130 to the verification service 140. The item object 160 can comprise various types of information related to the consuming user. For example, the item object 160 can include information related to the consuming user's interaction with the third party service 130 and/or one or more content items provided to the consuming user 120 via the third party service 130. In certain aspects, the item object can include information identifying the consuming user 120, information identifying one or more content items that the consuming user has viewed or interacted with.

Further to the above example, if the consuming user 120 visits the book store hosted by third party service 130 and browses the same book (e.g., the same content item) that was purchased by the producing user, information pertaining to the consuming user's viewing of the book may be included in the item object 160.

Once the item object 160 is received by the verification service 140, the verification service can use the information of the item object 160 to determine if any reference objects (e.g., the reference object 150) reside with the verification service 140 that may be provided to the consuming user 120. For example, based on the information of the content item (e.g., information identifying the consuming user 120 and/or the content item), the verification service can determine, based on the access control list of the reference object 150, whether information of the reference object 150 can be provided to the consuming user 120. If it is determined that one or more reference objects contain information that may be provided to the consuming user 120, then the one or more reference objects (e.g., the reference object 150) are sent from the verification service 140 to the third party service 130, to be provided to the consuming user 120.

In some implementations, information of one or more reference objects may be appended to content item information 170 that is provided or displayed to the consuming user 120.

Further to the above example, reference object 150 can contain information indicating that producing user 110 purchased a particular book, as well as a rating indicating how satisfied the producing user 110 was with the purchase. This information may then be provided to consuming user 120. For example, as consuming user 120 is viewing a listing for the same book (e.g., the same content item), an indication may be provided to consuming user 120 that one or more of his/her social networking associates purchased and liked that particular book.

In yet another example, third party service 130 could be a vendor of concert tickets, wherein the content items displayed to the producing user 110 are tickets for various events. Upon purchasing a concert ticket, producing user 110 may specify a seating location and instructions for one or more friends that may attend the same event. The producing user 110 may further specify a particular circle or group of social networking associates or online contacts that should be granted access to specified seating location and instructions. Accordingly, the reference object 150 can be generated based on the purchase by producing user 110 and can include, information identifying the third party service 130 (e.g., the vendor), information identifying a content item (e.g., the concert ticket), information identifying the producing user 110, information identifying an access control list (e.g., those friends/associates of the producing user 110 that are granted access to the reference object 150), and information regarding the seating location and instructions.

The reference object will then be sent from third party service 130 to verification service 140, where it will be stored. Subsequently, when a consuming user (e.g., the consuming user 120) visits the third party service 130 (e.g., the vendor) to buy tickets for the same concert, an item object (e.g., the item object 160) will be sent to the verification service 140. As detailed above, item object 160 can comprise information identifying the consuming user 120 and information identifying the vendor and/or the content item. Based on any portions of information contained in item object 160, the verification service 140 can determine that it would be appropriate to provide at least a portion of reference object 150 to consuming user 120, via the third party service 130.

Upon receipt of reference object 150, the third party service 130 can provide information of the reference object 150 to the consuming user 120. For example, as the consuming user 120 is browsing concert tickets on the vendor's website, information may be provided to the consuming user 120 that a friend (e.g., producing user 110), bought tickets for a particular concert and has been given a particular seating assignment. Based on the information provided about producing user 110, the consuming user 120 can purchase tickets for the same concert and choose a seating location near the producing user 110.

In certain aspects, producing user 110 may specify what types of information are shared (e.g., with one or more consuming users). Using the above example, the producing user 110 may decide that he/she wouldn't mind providing an indication to the consuming user 120 regarding the purchase of tickets for a particular concert; however, the producing user 110 would prefer that the consuming user 120 not be provided with the exact seat assignment.

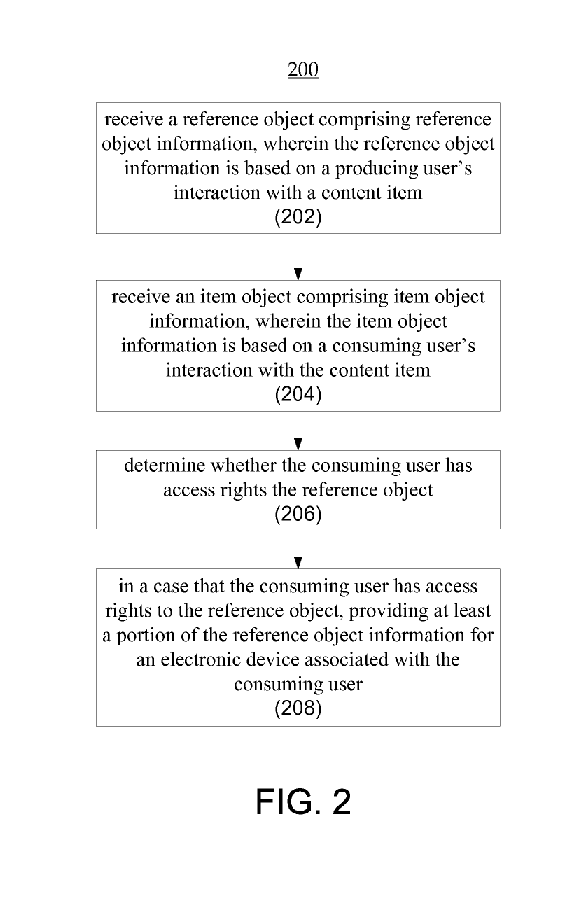

FIG. 2 illustrates steps of a method 200 for providing supplemental content item information to a consuming user, according to some aspects of the subject technology. The method 200 begins with step 202 in which a reference object is received, for example, from a third-party server. The reference object includes reference object information that is based, at least in part, on a first user's (e.g., “a producing user's”) interaction with a content item.

As discussed above, the content item can comprise different types of information that are available to one or more users e.g., via a computing device, such as a mobile computing device or smart phone, etc. For example, the content item could include images, text, video or sound information that are viewed, downloaded or received by an electronic system associated with producing user (e.g., the producing user's laptop or smart phone).

Additionally, the reference object information can comprise different types of information related to the producing user's interaction with the content item including, but not limited to, indications as to purchases made by the producing user and/or product or service reviews written by the producing user, etc. Although the reference object information can include various types of information created by (or regarding) the producing user and/or the content item, etc., in some embodiments the reference object information will include information for identifying (1) the site of origination (e.g., the third party service 130), (2) the producing user, (3) one or more content items and (4) an access control list (e.g., for specifying privacy rights with respect to one or more information items of the reference object).

In step 204, it is determined that a second user (e.g., a consuming user) is interacting with the content item. In certain aspects, information used to determine that the second user is interacting with the content item may be provided by a third party server or website.

Subsequently, in step 206, an item object comprising item object information is received, wherein the item object information is based on a consuming user's interaction with the content item. Although the item object can include various types of information related to the consuming user and/or the content item, in certain aspects the item object will comprise information for identifying (1) the site of origination (e.g., the third party service 130), (2) the consuming user, and (3) one or more content items (e.g., one or more content items with which the consuming user has interacted).

In step 208, it is determined that the consuming user has access rights to at least a portion of the reference object information. In some implementations, the determination as to whether the consuming user can access at least a portion of the reference object information will depend on whether access has been granted to the consuming user, for example, as specified by the access control list of the reference object. The access control list of the reference object can be based on user configurable privacy settings, for example, that have been set by the producing user in order to indicate which social networking associates may view information related to the producing user's online interactions (e.g., interactions with respect to the content item).

In step 210, at least a portion of the reference object information is provided for an electronic device associated with the consuming user. In some implementations, at least a portion of the information of the reference object will be provided to a computing device (e.g., a mobile computing device such as a tablet PC or a smart phone) that is used by the consuming user.

Any portion of the reference object information can be provided to the consuming user via an electronic device associated with the consuming user. By way of example, information of the reference object may be provided in conjunction with one or more content items that are displayed to the consuming user, e.g., on a display of a computing device associated with the consuming user.

In some examples, the reference object information can be used to indicate to the consuming user where on or more friends, family members or online contacts will be seated, for example on an airline flight, or in a concert venue. In other examples, the reference object information could be used to provide the consuming user with product/service ratings and/or reviews created by one or more of the consuming user's social networking associates.

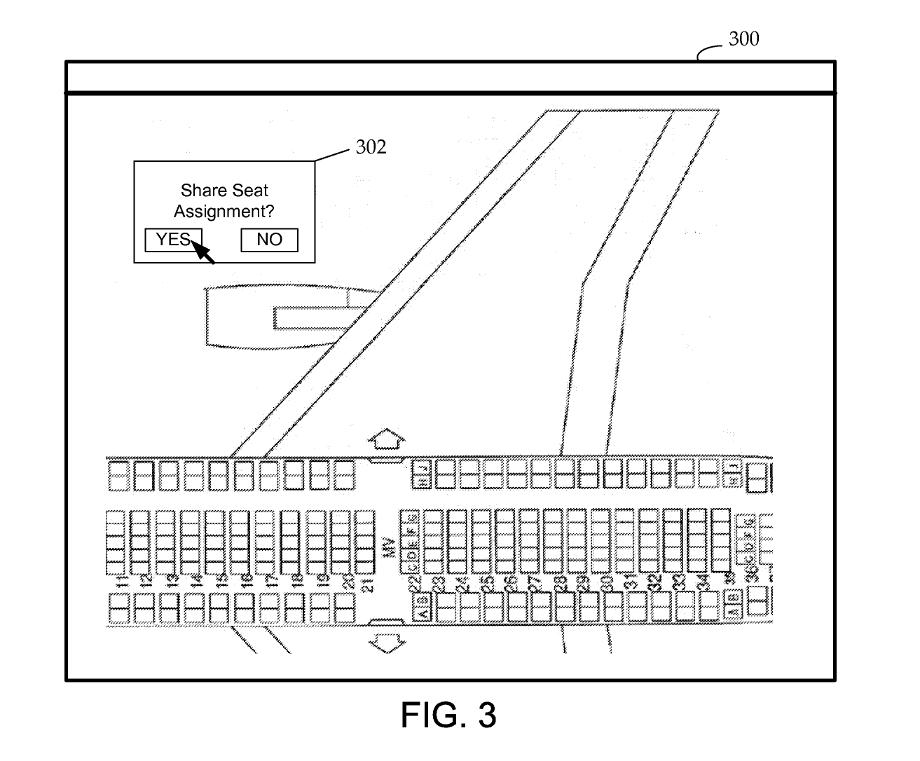

FIG. 3 illustrates an example of a graphical user interface (GUI) 300 that can be used to implement certain aspects of the subject disclosure. As illustrated, GUI 300 includes a selection box 302, that can be used to receive input from a producing user, for example, regarding one or more social networking associates with whom the producing user may wish to share information.

The GUI 300 could be used to display a third party website, such as an airline company website on which a producing user has purchased airline tickets. For example, the display of GUI 300 in FIG. 3 shows an airline seating chart representing seats on a flight in which tickets have been purchased by the producing user. In some implementations, the third party website may use an API to provide reference object information (e.g., to one or more servers) that includes details about the producing user's interaction with a content item (e.g., regarding the purchase of seats for a particular flight). Subsequently, the reference object information can be used to provide a different user (e.g., a consuming user) with details regarding the producing user's flight details. By way of example, the reference object information could be used to indicate (to a consuming user) which seats have been purchased on a particular flight by the producing user.

As illustrated in the example of FIG. 3, the producing user can optionally share information regarding the seat assignment (e.g., with one or more of the producing user's social networking associates), using selection box 302.

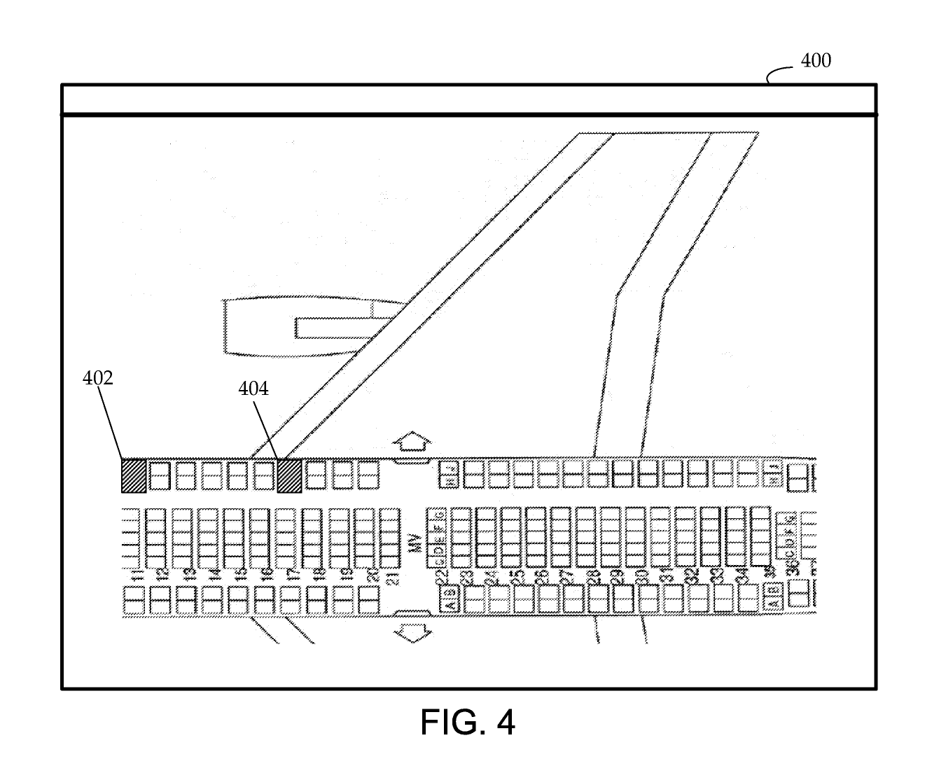

FIG. 4 illustrates an example of a GUI 400 that can be provided to a consuming user, for example by the same third party website on which the producing user purchased airline tickets. In certain aspects, the third party site (e.g., the airline website) can provide the GUI 400 which includes reference object information related to the producing user's purchase of airline tickets. As illustrated in the example of FIG. 4, the GUI 400 includes seat assignments 402 and 404 that indicate which seats were purchased by the producing user.

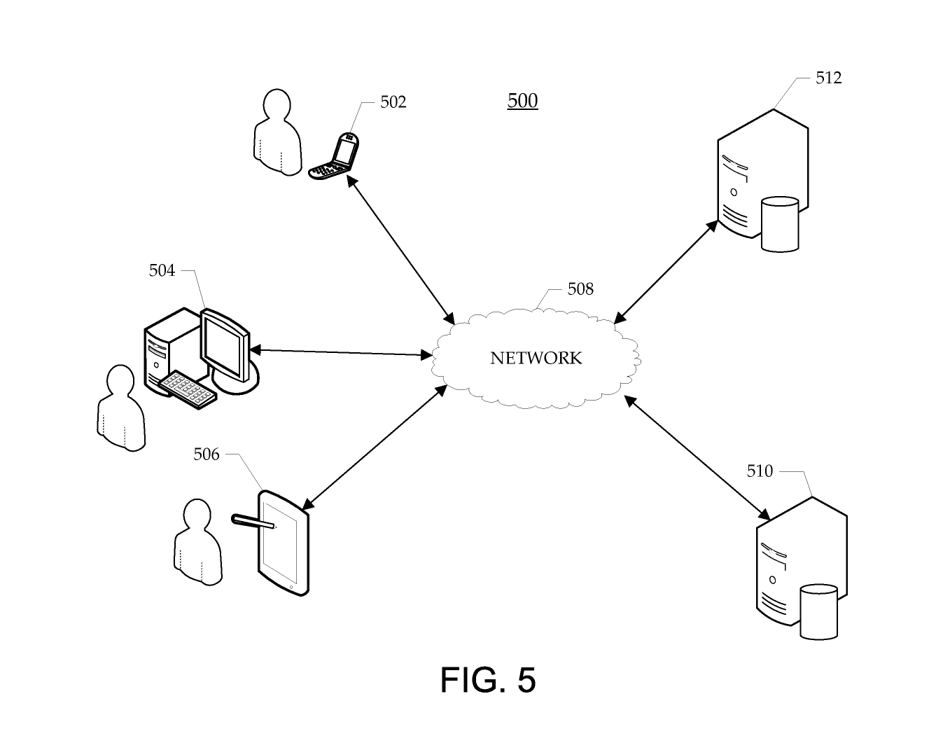

FIG. 5 illustrates an example of a network system with which some aspects of the subject technology can be implemented. In the example of FIG. 3, electronic device 502 is depicted as a smart phone, electronic device 504 is depicted as a personal computer, and electronic device 506 is depicted as a tablet computing device. The network system 300 further includes a network 508, a third party service 510, and a verification service 512. As illustrated, electronic devices 502, 504, 506, third party service 510 and verification service 512, are all communicatively coupled to the network 508.

In some aspects, the third party service 510 and the verification service 512 can be single computing devices. In other embodiments, the third party service 510 and the verification service 512 can comprise more than one computing device (e.g., multiple servers or multiple networks of computing devices), working together to perform the actions of one or more servers (e.g., a computing network, such as a social network).

In some implementations, third party service 510 can comprise multiple servers operating together on a proprietary network; for example, third party service 510 can include a single proprietary network comprising one or more email servers and or web servers.

The network 508 can include, any one or more of a wireless telephone network, a wired telephone network and/or a computer network such as a personal area network (PAN), a local area network (LAN), a campus area network (CAN), a metropolitan area network (MAN), a wide area network (WAN), a broadband network (BBN), or a network of networks such as the Internet.

In some examples, a producing user (e.g., a user associated with electronic device 502) can interact with a content item, for example, a content item displayed to the producing user via third party service 510. Based on the producing user's interaction with the content item and/or the third party service 510, a reference object can be created and forwarded to the verification service 512, via the network 508. The reference object is then stored at the verification service 512.

Subsequently, when a consuming user (e.g., a user associated with electronic device 506) visits the third party service 510 and views/interacts with a similar (or the same) content item, an item object will be generated by the third party service, and forwarded to the verification service 512, via the network 508. The verification service 512 can then determine whether or not the consuming user has access rights necessary to receive at least a portion of the information content of the reference object. If it is determined that the consuming user does not have the proper credentials, none of the information of the reference object will be returned to the third party service 510.

However, if the consuming user is deemed to have access rights to at least a portion of the information in the reference object (e.g., the consuming user is specified in an access control list of the reference object), then the verification service 512 will return at least a portion of the reference object to the third party service 510, via the network 508.

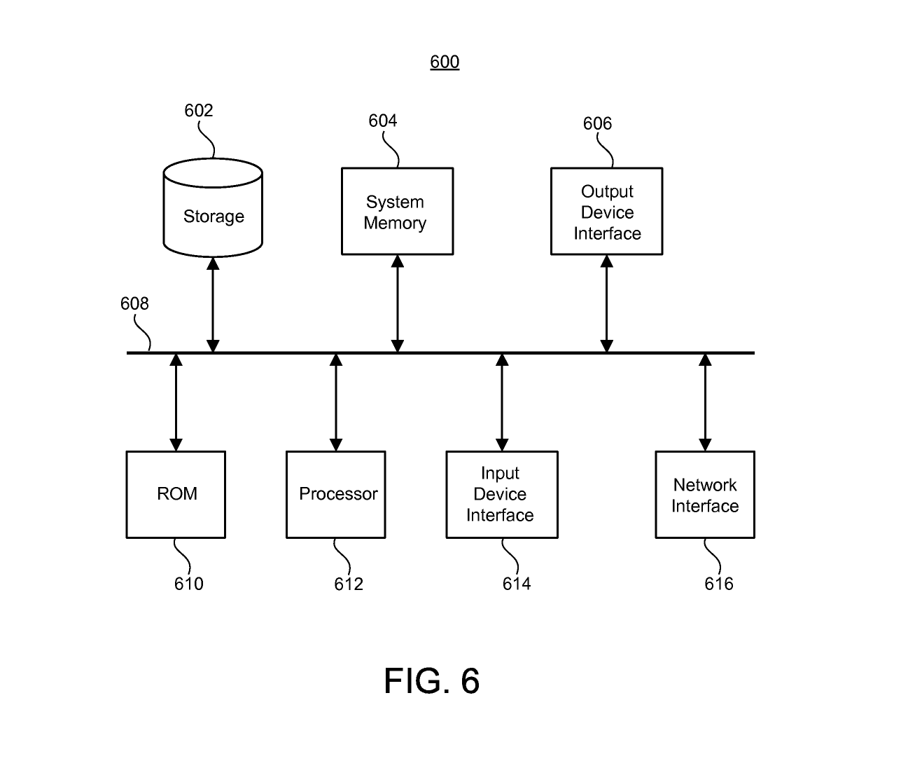

FIG. 6 illustrates an example of an electronic system that can be used for executing the steps of the subject disclosure. In some examples, the electronic system 600 can be a single computing device such as a server (e.g., the third party service 510 and/or verification service 512, discussed above). Furthermore, in some implementations, the electronic system 600 can be operated alone or together with one or more other electronic systems e.g., as part of a cluster or a network of computers, such as a social network.

As illustrated, the electronic system 600 comprises storage 602, a system memory 604, an output device interface 606, system bus 608, ROM 610, one or more processor(s) 612, input device interface 614 and a network interface 616. In some aspects, the system bus 608 collectively represents all system, peripheral, and chipset buses that communicatively connect the numerous internal devices of the electronic system 600. For instance, system bus 608 communicatively connects the processor(s) 612 with the ROM 610, the system memory 604, the output device interface 606 and the permanent storage device 602.

In some implementations, the various memory units, the processor(s) 612 retrieve instructions to execute (and data to process) in order to execute the steps of the subject technology. The processor(s) 612 can be a single processor or a multi-core processor in different implementations. Additionally, the processor(s) can comprise one or more graphics processing units (GPUs) and/or one or more decoders, depending on implementation.

The ROM 610 stores static data and instructions that are needed by the processor(s) 612 and other modules of the electronic system 600. Similarly, the processor(s) 612 can comprise one or more memory locations such as a CPU cache or processor in memory (PIM), etc. The storage device 602, is a read-and-write memory device. In some aspects, this device can be a non-volatile memory unit that stores instructions and data even when the electronic system 600 is without power. Some implementations of the subject disclosure can use a mass-storage device (such as solid state, magnetic or optical storage devices) e.g., a permanent storage device 602.

Other implementations can use one or more a removable storage devices (e.g., magnetic or solid state drives) such as permanent storage device 602. Although the system memory can be either volatile or non-volatile, in some examples the system memory 604 is a volatile read-and-write memory, such as a random access memory. System memory 604 can store some of the instructions and data that the processor needs at runtime.

In some implementations, the processes of the subject disclosure are stored in system memory 604, permanent storage device 602, ROM 610 and/or one or more memory locations embedded with the processor(s) 612. From these various memory units, processor(s) 612 retrieve instructions to execute and data to process in order to execute the processes of some implementations of the instant disclosure.

The bus 608 also connects to the input device interface 614 and output device interface 606. The input device interface 614 enables a user to communicate information and select commands to the electronic system 600. Input devices used with the input device interface 614 may include for example, alphanumeric keyboards and pointing devices (also called “cursor control devices”) and/or wireless devices such as wireless keyboards, wireless pointing devices, etc.

Finally, as shown in FIG. 6, bus 608 also communicatively couples the electronic system 600 to a network (not shown) through a network interface 616. It should be understood that the network interface 616 can be either wired, optical or wireless and can comprise one or more antennas and transceivers. In this manner, the electronic system 600 can be a part of a network of computers, such as a local area network (“LAN”), a wide area network (“WAN”), or a network of networks, such as the Internet (e.g., the network 508, as discussed above).

In practice the methods of the subject technology can be carried out by the electronic system 600. In some aspects, instructions for performing one or more of the method steps of the present disclosure will be stored on one or more memory devices such as the storage 602 and/or the system memory 604.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

All structural and functional equivalents to the elements of the various aspects described throughout this disclosure that are known or later come to be known to those of ordinary skill in the art are expressly incorporated herein by reference and are intended to be encompassed by the claims.

What is claimed is:

1. A computer-implemented method comprising:
receiving reference object information, wherein the reference object information is based on a first user's interaction with a content item;
determining that a second user is interacting with the content item;
receiving item object information, wherein the item object information is based on the second user's interaction with the content item;
determining that the second user has access rights to the reference object information based on the second user and the second user's interaction with the content item; and
providing at least a portion of the reference object information for an electronic device associated with the second user.

2. The method of claim 1, wherein the reference object information comprises a first user identification.

3. The method of claim 1, wherein the reference object information comprises a content item identification.

4. The method of claim 1, wherein the reference object information comprises an access control list.

5. The method of claim 4, wherein the access control list comprises information for identifying one or more social networking associates of the first user and wherein determining whether the second user has access rights to the reference object is based on the access control list.

6. The method of claim 1, wherein the reference object information comprises information related to the first user's preferences with respect to the content item.

7. The method of claim 1, wherein the reference object information comprises information related to a purchase made by the first user with respect to the content item.

8. The method of claim 1, wherein the electronic device associated with the second user receives the at least a portion of the reference object information from a third party service.

9. The method of claim 1, wherein the item object information comprises a content item identification.

10. A system comprising:
one or more processors; and
a computer-readable medium comprising instructions stored therein, which when executed by the processors, cause the processors to perform operations comprising:
receiving reference object information, wherein the reference object information comprises a first user identification and wherein at least a portion of the reference object information is based on a first user's interaction with a content item;
receiving item object information, wherein the item object information is based on a second user's interaction with the content item;
determining that the second user has access rights to the reference object information based on the second user and the second user's interaction with the content item; and
providing at least a portion of the reference object information for an electronic device associated with the second user.

11. The system of claim 10, wherein the reference object information comprises a content item identification.

12. The system of claim 10, wherein the reference object information comprises an access control list.

13. The system of claim 12, wherein the access control list comprises information for identifying one or more social networking associates of the first user and wherein determining whether the second user has access rights to the reference object is based on the access control list.

14. The system of claim 10, wherein the reference object information comprises information related to the first user's preferences with respect to the content item.

15. The system of claim 10, wherein the reference object information comprises information related to a purchase made by the first user with respect to the content item.

16. The system of claim 10, wherein the electronic device associated with the second user receives the at least a portion of the reference object information from a third party service.

17. The system of claim 10, wherein the item object information comprises a content item identification.

18. A computer-readable medium comprising instructions stored thereon, which when executed by a processor, cause the processor to perform operations comprising:
receiving reference object information, wherein the reference object information comprises a first user identification and wherein at least a portion of the reference object information is based on a first user's interaction with a content item;
determining that a second user is interacting with the content item;
receiving item object information, wherein the item object information comprises a second user identification, and wherein at least a portion of the item object information is based on the second user's interaction with the content item; and
providing at least a portion of the reference object information for an electronic device associated with the second user.

19. The computer-readable medium of claim 18, wherein the reference object information comprises an access control list.

20. The computer-readable medium of claim 18, wherein the access control list comprises information for identifying one or more social networking associates of the first user.
